(19) United States
(12) Patent Application Publication
(10) Pub. No.: US 2006/0002423 A1
(43) Pub. Date: Jan. 5, 2006

(54) Methods, systems, and computer program products for direct interworking between pseudo wires associated with different services

(76) Inventors: James William Rembert, Atlanta, GA (US); Michael Duckett, Alpharetta, GA (US); Steven Allen Wright, Roswell, GA (US)

Correspondence Address: MYERS BIGEL SIBLEY & SAJOVEC, P.A., P.O. BOX 37428, RALEIGH, NC, 27627, US

(21) Appl. No.: 10/881,811

(22) Filed: Jun. 30, 2004

(51) Int. Cl. H04J 3/16

(52) U.S. Cl. 370/466; 370/474

(57) ABSTRACT

A network is operated by receiving traffic associated with a first service on a first pseudo wire at a network node. The traffic is encapsulated with one or more layers associated with the first pseudo wire. One or more layers associated with the first pseudo wire are removed from the traffic. The traffic is encapsulated with one or more layers associated with a second pseudo wire so that the traffic is associated with a second service. The traffic, which is associated with the second service, is transmitted on the second pseudo wire.

### FIELD OF THE INVENTION

The present invention relates to communication networks, and, more particularly, to packet switched communication networks.

### BACKGROUND OF THE INVENTION

Multiprotocol label switching (MPLS) provides a technique for routing packet data based on a label field rather than a destination address. An MPLS network comprises a set of nodes, which are called label switched routers (LSRs), that switch/route packets based on a label that has been added to each packet. Labels are used to define a flow of packets between two nodes or, if packets are being broadcast in a multicast operation, between a source node and multiple destination nodes. A specific path through the LSRs, which is called a label switched path (LSP), is defined for each distinct flow, which is called a forwarding equivalence class (FEC). At intervening nodes in an LSP, an LSR may route the packet based on the MPLS label value, remove the MPLS label (pop a label), and/or impose an additional label (push a label). The label may be removed at the node from the packet at a node that is just prior to the destination node in a particular LSP. This process is sometimes referred to as “penultimate hop popping.”

Referring now to FIG. 1, an exemplary MPLS label and Internet Protocol (IP) packet are illustrated. The MPLS label is a 32-bit header that includes a 20-bit label field, a 3-bit Exp field that is reserved for experimental use, a 1-bit S field that is set to one for the oldest entry in the stack and zero for all other entries, and an 8-bit time-to-live (TTL) field that may be used to encode a hop count or time-to-live value. An MPLS label may also be referred to as an MPLS shim header. As shown in FIG. 1, multiple MPLS labels or shim headers may be included in a single IP packet. The MPLS labels or shim headers are organized as a last-in, first-out stack and are processed based on the top MPLS label or shim header. As discussed above, an LSR may add an MPLS label or shim header to the stack (push operation) or remove an MPLS label or shim header from the stack (pop operation).

Customers of telecommunications services may desire layer two data services that provide for diversity of access (e.g., Ethernet, frame relay, ATM, DSL, SONET, etc.) and interworking. Moreover, customers may desire layer two wide area network (WAN) connectivity across an entire service provider's region and beyond. In response, service providers may build MPLS backbones to provide layer two and/or layer three services from a single converged network. Existing RFC 2547bis and other IP-Virtual Private Network (VPN) technologies may provide layer three VPN services, but, unfortunately, these technologies do not address layer two VPN services. Some customers may request higher bandwidth service at key sites, such as data centers or headquarters locations, but these customers may not wish to modify their networks to use a common layer two technology.

Pseudo wire technology may be used to carry various types of layer two traffic over a packet switched network using, for example, IP or MPLS. In particular, a pseudo wire is a mechanism that emulates the essential attributes of a telecommunications service, such as frame relay, ATM, DSL, SONET, T1 leased line, etc., over a packet switched network. A pseudo wire may encapsulate service-specific data at an ingress port and carrying the data across an EP path and/or MPLS tunnel. Unfortunately, pseudo wire functionality does not provide for interworking between traffic associated with different layer two technologies.

### SUMMARY OF THE INVENTION

According to some embodiments of the present invention, a network is operated by receiving traffic associated with a first service on a first pseudo wire at a network node. The traffic is encapsulated with one or more layers associated with the first pseudo wire. One or more layers associated with the first pseudo wire are removed from the traffic. The traffic is encapsulated with one or more layers associated with a second pseudo wire so that the traffic is associated with a second service. The traffic, which is associated with the second service, is transmitted on the second pseudo wire.

In other embodiments of the present invention, the one or more layers associated with the first pseudo wire and the one or more layers associated with the second pseudo wire respectively comprise an encapsulation layer, a demultiplexer layer, and/or a network convergence layer.

In still other embodiments of the present invention, the traffic associated with the first service comprises a first payload having a first payload type of packet, cell, bit-stream, or structured bit-stream. The first payload having the first payload type is translated into a second payload having a second payload type of packet, cell, bit-stream, or structured bit-stream. The first payload type is different from the second payload type and the traffic comprising the second payload is associated with the second service.

In further embodiments of the present invention, the first service is asynchronous transfer mode (ATM), frame relay, point-to-point protocol (PPP)/high level data link control (HDLC), synchronous optical network (SONET), E1, E3, T1, T3, or Ethernet, and the second service is ATM, frame relay, PPP/HDLC, SONET, E1, E3, T1, T3, or Ethernet. The first and second services are different from each other.

In still further embodiments of the present invention, the network is an Internet Protocol (IP) network and/or a multiprotocol label switching (MPLS) network.

In still further embodiments of the present invention, the traffic is encapsulated based on a layer three (network layer) protocol associated with the network.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a conventional multiprotocol label switching (MPLS) label or shim header and internet protocol (LP) packet;

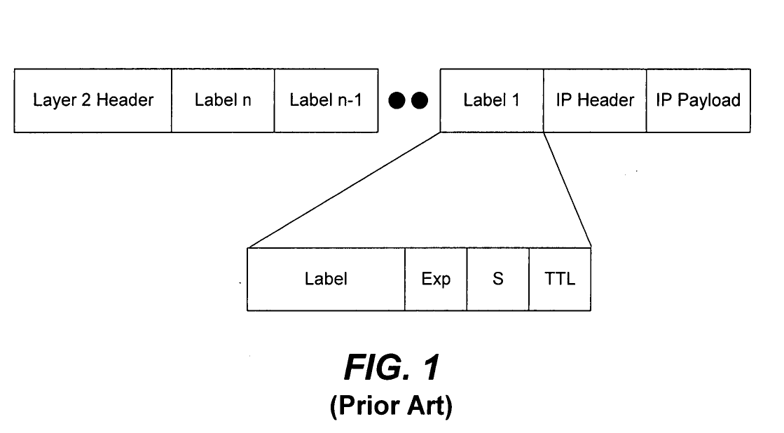

FIG. 2 is a block diagram that illustrates a packet switching network (PSN) in accordance with some embodiments of the present invention; and

FIG. 3 is a block diagram showing a conventional pseudo wire protocol layer structure; and

FIG. 4 is a flowchart that illustrates operations for direct interworking of traffic between pseudo wires associated with different services in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “protocol” refers to a defined set of rules that govern the exchange of data or information between two or more entities. In addition, a “protocol layer” refers generally to the hierarchical protocol structure represented by the open systems interconnection (OSI) model developed by the International Organization for Standardization in which layer one corresponds to the physical layer, layer two corresponds to the data link layer, layer three corresponds to the network layer, layer four corresponds to the transport layer, layer five corresponds to the session layer, layer six corresponds to the presentation layer, and layer seven corresponds to the application layer. It will be further understood that, in accordance with various embodiments of the present invention, protocol layers in addition to the seven-layer OSI model may be defined.

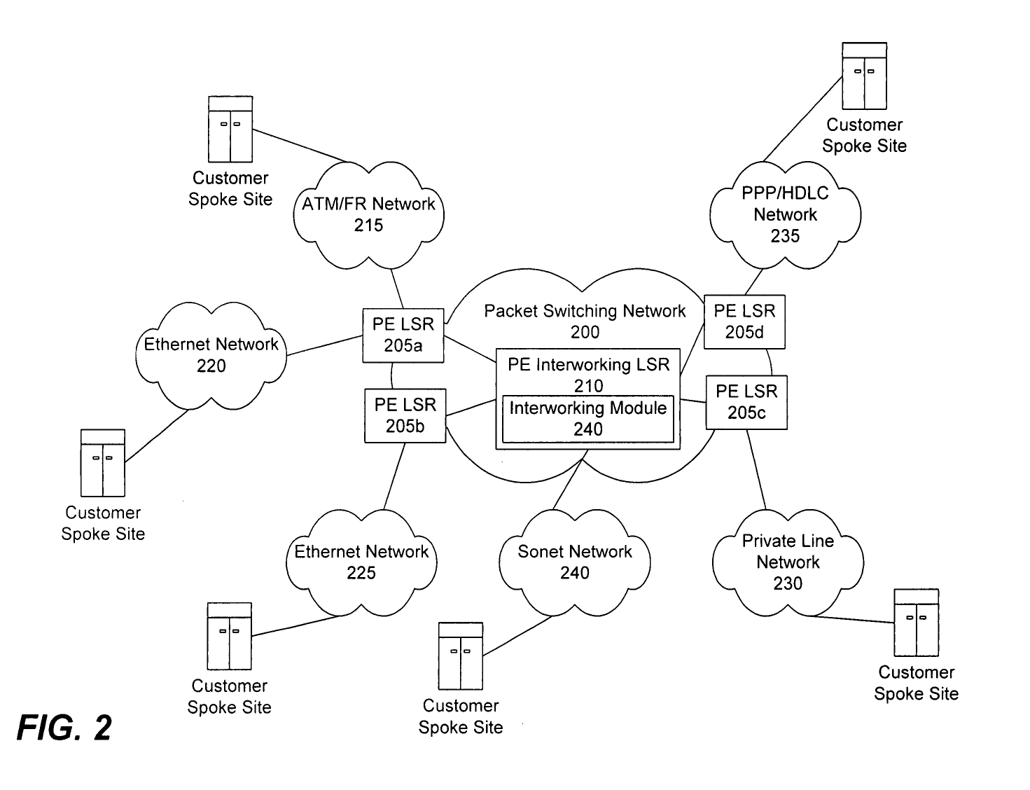

Referring now to FIG. 2, a service provider's packet switching network (PSN) 200, such as a multi-protocol label switching (MPLS) network or Internet protocol (IP) network, in accordance with some embodiments of the present invention, comprises provider edge (PE) label switched routers (LSRs) 205a,b,c,d and a PE interworking LSR 210. Because the PE LSRs 205a,b,c,d are on the edge of the SP's PSN, they may be called “label edged routers” (LERs). The PE LSRs 205a,b,c,d terminate traffic from multiple spoke sites associated with a customer, for example. In particular, the PE LSR 205a terminates traffic from an ATM/Frame Relay network 215 and an Ethernet network 220; the PE LSR 205b terminates traffic from an Ethernet network 225; the PE LSR 205c terminates traffic from a private line network 230; and the PE LSR 205d terminates traffic from a point-to-point protocol (PPP)/high level data link control (HDLC) network 235. The private line network 230 may use any time division multiplexing technology that provides synchronous transport (e.g., DS1, DS3, E1, E3, T1, T3, and SONET)

The PE Interworking LSR 210 may be coupled to the PE LSRs 205a,b,c,d via pseudo wires. For example, an ATM/Frame Relay pseudo wire may be used to communicatively couple PE LSR 205a to the PE Interworking LSR 210, an Ethernet pseudo wire may be used to communicatively couple PE LSR 205b to the PE Interworking LSR 210; a T1 pseudo wire may be used to communicatively couple PE LSR 205c to the PE Interworking LSR 210; and a PPP pseudo wire may be used to communicatively couple PE LSR 205d to the PE Interworking LSR 210. The PE Interworking LSR 210 comprises an interworking module 240 that may be configured to interwork traffic between two pseudo wires associated with different services.

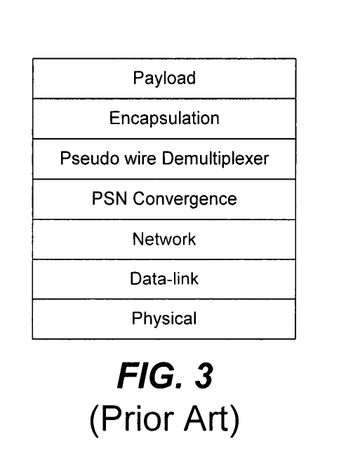

As discussed above, a pseudo wire is a mechanism that emulates the essential attributes of a telecommunications service, such as frame relay, ATM, DSL, SONET, T1 leased line, etc., over a packet switched network. Referring now to FIG. 3, a conventional pseudo wire protocol structure is illustrated. The physical, data-link, and network layers correspond to layers defined in the OSI model and will not be described further herein. The encapsulation, pseudo wire demultiplexer, and PSN convergence layers are used to encapsulate packet traffic to define a pseudo wire. In more detail, the payload is transported over the encapsulation layer. The encapsulation layer contains any information that is not present in the payload that is needed to transmit the payload to a customer edge device. If no additional information is needed that is not already in the payload, then this layer may be null. The pseudo wire demultiplexer layer allows multiple pseudo wires to be setup over a single PSN tunnel. The PSN convergence layer provides a consistent interface to the pseudo wire so that the pseudo wire may be independent of the underlying network layer.

Returning to FIG. 2, the interworking module 240 may be configured to receive traffic associated with a first service (e.g., ATM/Frame relay) on a first pseudo wire and to process this traffic by removing one or more pseudo wire protocol layers discussed above and replacing the removed layers with one or more pseudo wire protocol layers associated with a second service (e.g., Ethernet). The traffic may then be transmitted on a second pseudo wire associated with the second service. In addition, the interworking module 240 may translate the payloads between various payload types associated with particular service types as will be discussed in more detail below.

Although FIG. 2 illustrates an exemplary PSN, it will be understood that the present invention is not limited to such configurations, but is intended to encompass any configuration capable of carrying out the operations described herein. It will be appreciated that, in accordance with some embodiments of the present invention, the functionality of the interworking module 240 may be implemented using discrete hardware components, one or more application specific integrated circuits (ASICs), a programmed digital signal processor or microcontroller, a program stored in a memory and executed by a processor, and/or combinations thereof. In this regard, computer program code for carrying out operations of the interworking module 240 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

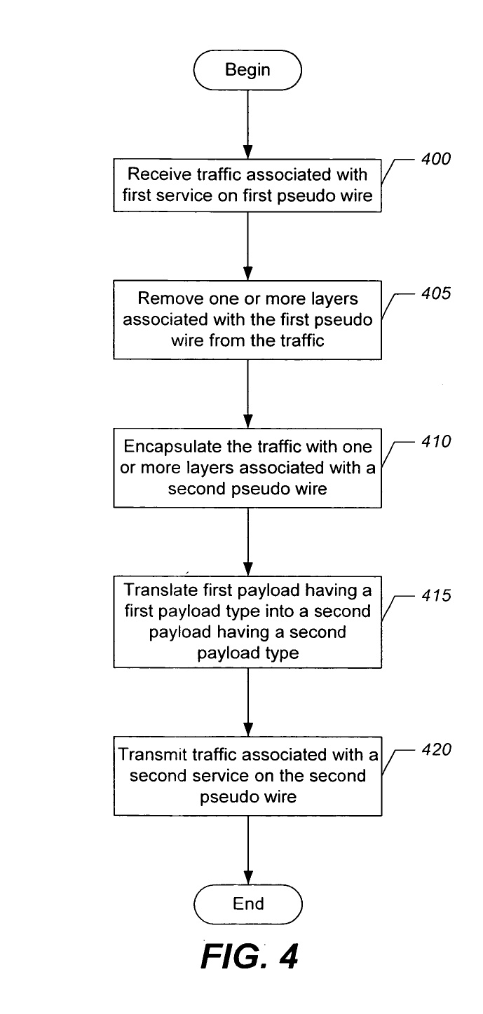

Operations for interworking traffic between pseudo wires associated with different services, in accordance with some embodiments of the present invention, will now be described with reference to FIGS. 4 and 2. Referring now to FIG. 4, operations begin at block 400 where the PE Interworking LSR 210 receives traffic associated with a first service on a first pseudo wire. For example, the PE Interworking LSR may receive traffic associated with an ATM/Frame Relay service on the pseudo wire that communicatively couples the PE LSR 205a to the PE Interworking LSR 210. The interworking module 240 may then remove one or more protocol layers associated with the first pseudo wire from the packet traffic at block 405. These protocol layers may include the encapsulation, pseudo wire demultiplexer, and/or PSN convergence layers as discussed above with reference to FIG. 3.

At block 410, the interworking module 240 may then encapsulate the traffic with one or more protocol layers associated with a second pseudo wire, such as, for example, the pseudo wire communicatively coupling the PE interworking LSR 210 and the PE LSR 205b. In this example, the interworking module may encapsulate the traffic with pseudo wire protocol layers that are associated with the Ethernet service. In accordance with various embodiments of the present invention, the encapsulation of the traffic with the one or more protocol layers associated with the second pseudo wire may be based on rules associated with the particular layer three protocol (i.e., network layer protocol) used in the PSN. For example, if routed encapsulation is used for ATM, Frame Relay, and/or DSL in which the service provider's network is responsible for inserting,Ethernet header information into the ATM/Frame Relay cell, then different pseudo wire encapsulation rules may be applied depending on the type of PSN network that is in place. Alternatively, if bridged encapsulation is used in which the Ethernet header information is inserted into the ATM/Frame relay cell by the customer, then the pseudo wire encapsulation is independent of the layer three protocol.

At block 415, the interworking module 240 may translate the payload received on the first pseudo wire, which has a first payload type, into a second payload that has a second payload type. In general, there are four generic payload types: packet, cell, bit-stream, and structured bit-stream. The packet payload type may be associated with pseudo wire services such as Ethernet, PPP/HDLC, and frame relay, for example. The cell payload type may be associated with the ATM pseudo wire service, for example. The bit-stream payload type may be associated with pseudo wire services such as E1, E3, T1, and T3, for example. The structured bit-stream payload type may be associated with the SONET pseudo wire service, for example. Thus, in the example in which traffic is received from the ATM/FR network 215 through the PE LSR 205 and is being routed to the Ethernet network 225 via the PE LSR 205b, the interworking module 240 translates ATM cell payload type into an Ethernet packet payload type.

At block 420, the PE Interworking LSR 210 transmits the traffic, which is now associated with a second service-on the second pseudo wire. In the example discussed above, the PE Interworking LSR 210 transmits the traffic that has been received on the pseudo wire communicatively coupling the PE LSR 205a to the PE Interworking LSR 210, which is associated with the ATM/Frame relay service, on the pseudo wire communicatively coupling the PE Interworking LSR 210 to the PE LSR 205b, which is associated with the Ethernet service.

Advantageously, the present invention may allow traffic to be interworked between pseudo wires of different types so as to provide an any to any connection oriented service for multiple layer two connection types. Moreover, embodiments of the present invention are not limited to a single layer three protocol.

The flowchart of FIG. 4 illustrates the architecture, functionality, and operations of some embodiments of methods, systems, and computer program products for direct interworking between pseudo wires associated with different services. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a network, comprising:
receiving traffic associated with a first service on a first pseudo wire at a network node, the traffic being encapsulated with at least one layer associated with the first pseudo wire;
removing the at least one layer associated with the first pseudo wire from the traffic;
encapsulating the traffic with at least one layer associated with a second pseudo wire so that the traffic is associated with a second service; and
transmitting the traffic associated with the second service on the second pseudo wire.

2. The method of claim 1, wherein the at least one layer associated with the first pseudo wire and the at least one layer associated with the second pseudo wire respectively comprise an encapsulation layer, a demultiplexer layer, and/or a network convergence layer.

3. The method of claim 1, wherein the traffic associated with the first service comprises a first payload having a first payload type of packet, cell, bit-stream, or structured bit-stream, the method further comprising:.
translating the first payload having the first payload type into a second payload having a second payload type of packet, cell, bit-stream, or structured bit-stream, the first payload type being different from the second payload type and the traffic being associated with the second service comprising the second payload.

4. The method of claim 1, wherein the first service is asynchronous transfer mode (ATM), frame relay, point-to-point protocol (PPP)/high level data link control (HDLC), synchronous optical network (SONET), E1, E3, T1, T3, or Ethernet, and wherein the second service is ATM, frame relay, PPP/HDLC, SONET, E1, E3, T1, T3, or Ethernet, the first service being different from the second service.

5. The method of claim 1, wherein the network is an Internet Protocol (IP) network and/or a multiprotocol label switching (MPLS) network.

6. The method of claim 1, wherein encapsulating the traffic comprises encapsulating the traffic with the at least one layer associated with the second pseudo wire so that the traffic is associated with the second service based on a layer three (network layer) protocol associated with the network.

7. A system for operating a network, comprising:
means for receiving traffic associated with a first service on a first pseudo wire at a network node, the traffic being encapsulated with at least one layer associated with the first pseudo wire;
means for removing the at least one layer associated with the first pseudo wire from the traffic;
means for encapsulating the traffic with at least one layer associated with a second pseudo wire so that the traffic is associated with a second service; and
means for transmitting the traffic associated with the second service on the second pseudo wire.

8. The system of claim 7, wherein the at least one layer associated with the first pseudo wire and the at least one layer associated with the second pseudo wire respectively comprise an encapsulation layer, a demultiplexer layer, and/or a network convergence layer.

9. The system of claim 7, wherein the traffic associated with the first service comprises a first payload having a first payload type of packet, cell, bit-stream, or structured bit-stream, the system further comprising:
means for translating the first payload having the first payload type into a second payload having a second payload type of packet, cell, bit-stream, or structured bit-stream, the first payload type being different from the second payload type and the traffic being associated with the second service comprising the second payload.

10. The system of claim 7, wherein the first service is asynchronous transfer mode (ATM), frame relay, point-to-point protocol (PPP)/high level data link control (HDLC), synchronous optical network (SONET), E1, E3, T1, T3, or Ethernet, and wherein the second service is ATM, frame relay, PPP/HDLC, SONET, E1, E3, T1, T3, or Ethernet, the first service being different from the second service.

11. The system of claim 7, wherein the network is an Internet Protocol (IP) network and/or a multiprotocol label switching (MPLS) network.

12. The system of claim 7, wherein the means for encapsulating the traffic comprises means for encapsulating the traffic with the at least one layer associated with the second pseudo wire so that the traffic is associated with the second service based on a layer three (network layer) protocol associated with the network.

13. A computer program product for operating a network, comprising:
a computer readable storage medium having computer readable program code embodied therein, the computer readable program code comprising:
computer readable program code configured to receive traffic associated with a first service on a first pseudo wire at a network node, the traffic being encapsulated with at least one layer associated with the first pseudo wire;
computer readable program code configured to remove the at least one layer associated with the first pseudo wire from the traffic;
computer readable program code configured to encapsulate the traffic with at least one layer associated with a second pseudo wire so that the traffic is associated with a second service; and
computer readable program code configured to transmit the traffic associated with the second service on the second pseudo wire.

14. The computer program product of claim 13, wherein the at least one layer associated with the first pseudo wire and the at least one layer associated with the second pseudo wire respectively comprise an encapsulation layer, a demultiplexer layer, and/or a network convergence layer.

15. The computer program product of claim 13, wherein the traffic associated with the first service comprises a first payload having a first payload type of packet, cell, bit-stream, or structured bit-stream, the system further comprising:
computer readable program code configured to translate the first payload having the first payload type into a second payload having a second payload type of packet, cell, bit-stream, or structured bit-stream, the first payload type being different from the second payload type and the traffic being associated with the second service comprising the second payload.

16. The computer program product of claim 13, wherein the first service is asynchronous transfer mode (ATM), frame relay, point-to-point protocol (PPP)/high level data link control (HDLC), synchronous optical network (SONET), E1, E3, T1, T3, or Ethernet, and wherein the second service is ATM, frame relay, PPP/HDLC, SONET, E1, E3, T1, T3, or Ethernet, the first service being different from the second service.

17. The computer program product of claim 13, wherein the network is an Internet Protocol (IP) network and/or a multiprotocol label switching (MPLS) network.

18. The computer program product of claim 13, wherein the computer readable program code configured to encapsulate the traffic comprises computer readable program code configured to encapsulate the traffic with the at least one layer associated with the second pseudo wire so that the traffic is associated with the second service based on a layer three (network layer) protocol associated with the network.
